(19) United States
(12) Patent Application Publication
(10) Pub. No.: US 2025/0372690 A1
(43) Pub. Date: Dec. 4, 2025

(54) HEATING PRESS FOR FOLDING PROCESS OF TERRACE AND MANUFACTURING METHOD OF BATTERY CELL

(71) Applicant: SK On Co., Ltd., Seoul (KR)

(72) Inventors: Jun Hui JEONG, Daejeon (KR); Seung Hyeon CHEON, Daejeon (KR); Sung Yeop KIM, Daejeon (KR)

(21) Appl. No.: 19/208,548

(22) Filed: May 14, 2025

(30) Foreign Application Priority Data
May 29, 2024 (KR) 10-2024-0070288

(51) Int. Cl. H01M 10/04; H01M 50/105

(52) U.S. Cl. CPC H01M 10/0404; H01M 10/0481; H01M 50/105

(57) ABSTRACT

A heating press for pressing a folded portion formed on a terrace disposed on at least a portion of a circumference of an electrode-accommodating portion of a battery cell, including a first press including a first pressing surface pressing a first surface of the folded portion; and a second press including a second pressing surface pressing a second surface of the folded portion and a protruding pressing surface pressing an inner side region of the terrace, wherein the protruding pressing surface protrudes from the second pressing surface toward the first pressing surface and presses the inner side region together with the first pressing surface, and the inner side region is located between the folded portion and the electrode-accommodating portion, is disclosed.

### CROSS-REFERENCE TO RELATED APPLICATION(S)

This patent document claims the priority and benefits of Korean Patent Application No. 10-2024-0070288 filed on May 29, 2024, the disclosure of which is incorporated herein by reference in its entirety.

### TECHNICAL FIELD

The disclosure and implementations disclosed in this patent document generally relate to a heating press for a folding process of a terrace of a battery cell, and a method for manufacturing a battery cell.

### BACKGROUND

Secondary battery cells have the convenience of being able to be charged and discharged, unlike primary batteries, and may be thus attracting significant attention as power sources for various mobile devices, electric vehicles, energy storage devices, or the like.

A secondary battery cell may be manufactured as a pouch-type battery cell or a can-type battery cell. The pouch-type battery cell may have a structure in which an electrode assembly is accommodated in a flexible pouch case. The can-type battery cell may have a structure in which an electrode assembly is accommodated in a rigid case, and may be formed as a cylindrical battery cell or a square battery cell.

A pouch case of the pouch-type battery cell may include a terrace disposed on at least a portion of an electrode-accommodating portion accommodating an electrode assembly, or a circumference of the electrode-accommodating portion, and having a shape extending outwardly from the electrode-accommodating portion. A portion of the terrace may be formed by heat-melting (compressing) an inner layer of the pouch case to form a sealed portion. The sealed portion may seal the electrode-accommodating portion from the outside.

### SUMMARY

A pouch-type battery cell may be fused by applying heat to a pouch case in order to prevent loss of an electrolyte and suppress infiltration of moisture in an electrode-accommodating portion, to form a sealed portion. The pouch case may include a resin layer, and may generate a phenomenon of pushing a portion of a resin melted due to heat and pressure during a fusion process outwardly from the sealed portion. The portion of the resin pushed outwardly from the sealed portion in this manner may have an irregular shape, and may be cured in an unstable state, to form an unstable region. This unstable region may extend from a boundary between a sealed portion, which may be a sealed region, and a non-sealed portion, which may be an unsealed region, toward the non-sealed portion.

Meanwhile, in the pouch-type battery cell, in order to block the electrode-accommodating portion from the outside, the sealed portion should secure a width of the sealed portion in a certain distance or more. When the width of the sealed portion increases, an overall volume of a battery cell may increase to adversely affect an energy density of the battery cell. Therefore, a process of folding a terrace in which an electrode lead is not disposed may generally be performed in a process of manufacturing the battery cell.

Since an unstable region formed in a sealing process has different thicknesses and different properties of the resin layer, the unstable region may have a vulnerable portion such as cracks occurring during a folding process, or the like, and insulation may be destroyed, causing a problem in which the battery cell should be discarded. In addition, when the folding process is performed on the battery cell having a low degree of insulation, there may be a problem in which a degree of insulation is further worsened and the battery cell should be discarded.

According to an aspect of the present disclosure, a heating press for a folding process of a terrace capable of improving insulation performance of a battery cell, and a method for manufacturing a battery cell, may be provided.

According to an aspect of the present disclosure, a heating press for a folding process of a terrace capable of alleviating a phenomenon in which thicknesses and properties of a resin layer are uneven in a region in which a molten resin is pushed toward a non-sealed portion, and a method for manufacturing a battery cell, may be provided.

According to an aspect of the present disclosure, a heating press for a folding process of a terrace capable of restoring insulation performance of a battery cell or improving the insulation performance of the battery cell, as compared to a previous process, and a method for manufacturing a battery cell, may be provided.

According to an aspect of the present disclosure, a heating press for a folding process of a terrace capable of reducing an insulation defect of a battery cell, and a method for manufacturing a battery cell, may be provided.

A battery cell manufactured by a heating press for a folding process of a terrace and a method for manufacturing a battery cell of the present disclosure may be widely applied to devices within green technology fields such as an electric vehicle, a battery charging station, or solar power generation, wind power generation, or the like using batteries, or the like. In addition, the battery cell manufactured by a folding guide line forming device of the present disclosure may be used in an eco-friendly electric vehicle, a hybrid vehicle, or the like to help reduce climate change by suppressing air pollution and greenhouse gas emissions.

In some embodiments of the present disclosure, a heating press for pressing a folded portion formed on a terrace disposed on at least a portion of a circumference of an electrode-accommodating portion of a battery cell, includes a first press including a first pressing surface pressing a first surface of the folded portion; and a second press including a second pressing surface pressing a second surface of the folded portion and a protruding pressing surface pressing an inner side region of the terrace, wherein the protruding pressing surface protrudes from the second pressing surface toward the first pressing surface and presses the inner side region together with the first pressing surface, and the inner side region is located between the folded portion and the electrode-accommodating portion.

In an embodiment, the folded portion may have a shape in which a sealed portion of the terrace is folded 180 degrees and overlaps, and the inner side region pressed by the protruding pressing surface may include a region in which the folded portion does not overlap.

In an embodiment, the terrace may include a sealed portion, which is a sealed region, and a non-sealed portion, which is an unsealed region, and the inner side region pressed by the protruding pressing surface may include at least a portion of the non-sealed portion.

In an embodiment, the inner side region may include a boundary between the sealed portion and the non-sealed portion, and the protruding pressing surface may simultaneously press a portion of the sealed portion and a portion of the non-sealed portion.

In an embodiment, the folded portion may have a shape in which the sealed portion overlaps by folding based on an outer side folding line, and the inner side region may include a region in which an inner side folding line is located, the inner side folding line being provided for folding the terrace between the outer side folding line and the electrode-accommodating portion.

In an embodiment, the protruding pressing surface may include a planar surface protruding from the second pressing surface to a preset height.

In an embodiment, the preset height may have a value between 0.8 and 1.2 times a thickness of a sealed portion of the terrace.

In an embodiment, the first pressing surface may press the folded portion, together with the second pressing surface.

In an embodiment, the heating press may further include a heating unit heating at least one of the first press or the second press, wherein a preset temperature of the heating unit may have a value lower than a heating temperature of a process of forming a sealed portion on the terrace.

In an embodiment, a heating temperature of the inner side region pressed by the protruding pressing surface may be lower than a melting temperature of a resin layer provided on the terrace.

In an embodiment, a heating temperature of the inner side region pressed by the protruding pressing surface may be 0.7 to 1.2 times a melting temperature of a resin layer provided on the terrace.

In some embodiments of the present disclosure, a method for manufacturing a battery cell, includes a sealing process of forming a sealed portion on a terrace disposed on at least a portion of a circumference of an electrode-accommodating portion of a pouch case; a first folding process of first folding the sealed portion based on an outer side folding line to form a folded portion; a pressing process of pressing the folded portion; and a second folding process of additionally folding the folded portion based on an inner side folding line, wherein the pressing process presses an inner side region located between the folded portion and the electrode-accommodating portion, together with the folded portion.

In an embodiment, the folded portion may have a shape in which the sealed portion is folded 180 degrees and overlaps, and the inner side region pressed in the pressing process may include a region in which the folded portion does not overlap.

In an embodiment, the terrace may include the sealed portion and a non-sealed portion, which is an unsealed region, and the inner side region pressed in the pressing process may include at least a portion of the non-sealed portion.

In an embodiment, the inner side region may include a boundary between the sealed portion and the non-sealed portion, and the pressing process may simultaneously press a portion of the sealed portion and a portion of the non-sealed portion.

### BRIEF DESCRIPTION OF DRAWINGS

Certain aspects, features, and advantages of the present disclosure may be illustrated by the following detailed description with reference to the accompanying drawings.

FIG. 1 is a schematic diagram illustrating an example of a battery cell in which a sealed portion is formed in a terrace portion.

FIGS. 2A to 2F sequentially illustrate a process of forming a folded portion in a sealed portion of a battery cell, and are cross-sectional views of FIG. 1, taken along line I-I′.

FIG. 3A is a schematic diagram illustrating an enlarged portion of portion “A” of FIG. 1.

FIG. 3B is a cross-sectional view illustrating a state in which a folding guide line is formed in a cross-section of FIG. 3A, taken along line II-II′.

FIG. 4 is a perspective view illustrating a battery cell according to an embodiment.

FIG. 5 is a schematic diagram illustrating a heating press according to a comparative example.

FIG. 6 is a schematic diagram illustrating a heating press according to an embodiment.

FIG. 7 is a schematic diagram of a battery cell processed by the heating press of FIG. 6.

FIG. 8 is a schematic diagram of a battery cell processed by a heating press according to a modified embodiment.

FIG. 9 is a flow chart illustrating a method for manufacturing a battery cell according to an embodiment.

FIG. 10 is a flow chart illustrating a method for manufacturing a battery cell according to another embodiment.

### DETAILED DESCRIPTION

The same reference numbers or symbols in each drawing attached to this specification indicate parts or components that perform substantially the same function. For convenience of explanation and understanding, different embodiments may be described using the same reference numerals or symbols. That is, even if components having the same reference number may be illustrated in multiple drawings, the multiple drawings do not all represent an embodiment.

In the following description, singular expressions include plural expressions unless the context clearly dictates otherwise. Terms such as “include,” “comprise,” or the like may be intended to designate the presence of features, numbers, steps, operations, components, parts, or combinations thereof described in the specification, and one or more other features or numbers, it should be understood that this does not exclude in advance possibility of presence or addition of steps, operations, components, parts, or combinations thereof.

In addition, in the following description, expressions such as upward, above, on, upper portion, downward, below, lower portion, lateral, side surface, forward, front, rearward, rear, or the like may be expressed based on the direction illustrated in the drawings, and it should be noted in advance that when a direction of an object changes, it may be expressed differently.

In addition, in this specification and claims, terms including ordinal numbers such as “first,” “second,” or the like may be used to distinguish between components. These ordinal numbers may be used to distinguish identical or similar components from each other, and the meaning of the term should not be interpreted limitedly due to the use of these ordinal numbers. For example, components combined with these ordinal numbers should not be interpreted as having a limited order of use or arrangement based on the number. As necessary, each ordinal number may be used interchangeably.

Hereinafter, embodiments of the present disclosure will be described with reference to the attached drawings. However, the idea of the present disclosure is not limited to the presented embodiments.

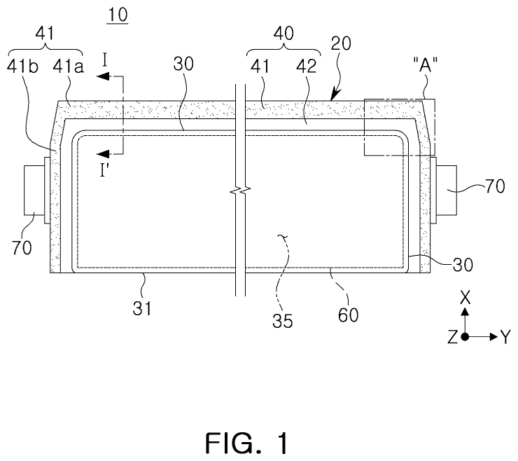

FIG. 1 is a schematic diagram illustrating an example of a battery cell 10 in which a sealed portion is formed in a terrace portion.

Referring to FIG. 1, a battery cell 10 may include a pouch case 20 and an electrode assembly 60 accommodated in the pouch case 20. An electrode lead 70 connected to the electrode assembly 60 may be exposed to an outside of the pouch case 20. The electrode assembly 60 may include a positive electrode plate, a negative electrode plate, and a separator. The separator may be disposed between the positive electrode plate and the negative electrode plate.

The pouch case 20 may include an electrode-accommodating portion 30 forming an accommodating space 35 accommodating the electrode assembly 60, and a terrace 40 disposed on at least a portion of a circumference of the electrode-accommodating portion 30 and extending from the electrode-accommodating portion 30 in an outward direction.

The terrace 40 may be sealed by heat fusion at a border or a portion adjacent to the border. The terrace 40 may include a sealed portion 41, which may be a sealed region, and a non-sealed portion 42, which may be a non-sealed region. The sealed portion 41 may form a sealed region, and the non-sealed portion 42 may form a non-sealed region. The non-sealed portion 42 may be formed between the sealed portion 41 and the electrode-accommodating portion 30. The sealed portion 41 may protect the electrode assembly 60 from the outside by heat fusion of contacting surfaces of the pouch case 20.

The sealed portion 41 may include a first sealed portion 41a in which the electrode lead 70 is not disposed, and a second sealed portion 41b in which the electrode lead 70 is disposed. When forming an electrode-accommodating portion 30 by folding one pouch case 20, three surfaces among four surfaces of the electrode-accommodating portion 30 may be exposed, and one surface (31) may have a closed shape. The sealed portion 41 may be formed on the three exposed surfaces of the electrode-accommodating portion 30.

A battery cell 10 according to an embodiment is not limited to a structure in which the sealed portion 41 is formed on three surfaces of the electrode-accommodating portion 30. For example, the battery cell 10 may also have a configuration in which the electrode-accommodating portion 30 is formed by overlapping two pouch cases 20. In this case, the sealed portion 41 may be formed on all four surfaces of the electrode-accommodating portion 30.

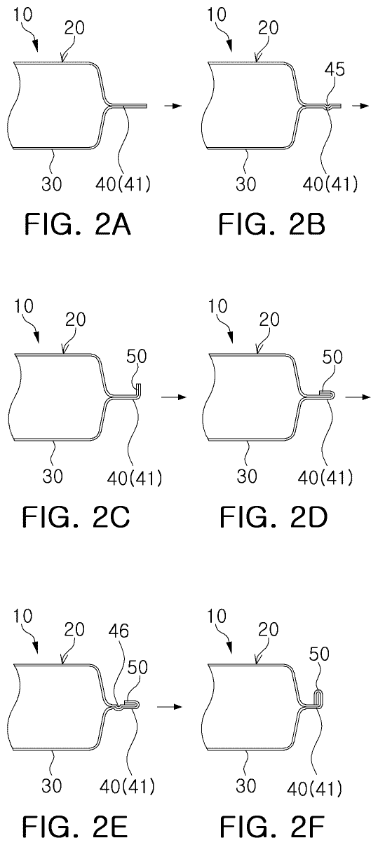

FIGS. 2A to 2F sequentially illustrate a process of forming a folded portion 50 on a terrace 40 of a battery cell 10. FIGS. 2A to 2F may be cross-sectional views of FIG. 1, taken along line I-I′, respectively, with the electrode assembly 60 omitted.

The terrace 40 may be folded to increase bonding reliability of the sealed portion 41 and to reduce a volume occupied by the terrace 40.

FIG. 2A, the terrace 40 of the battery cell 10 may have an angle of 0 degree before a folding process is performed. The folding process may fold the first sealed portion 41a of the sealed portion 41 of the terrace 40 in which the electrode lead 70 is not disposed.

In an embodiment, the terrace 40 may form the folded portion 50 folded at a specific angle after undergoing at least one folding process.

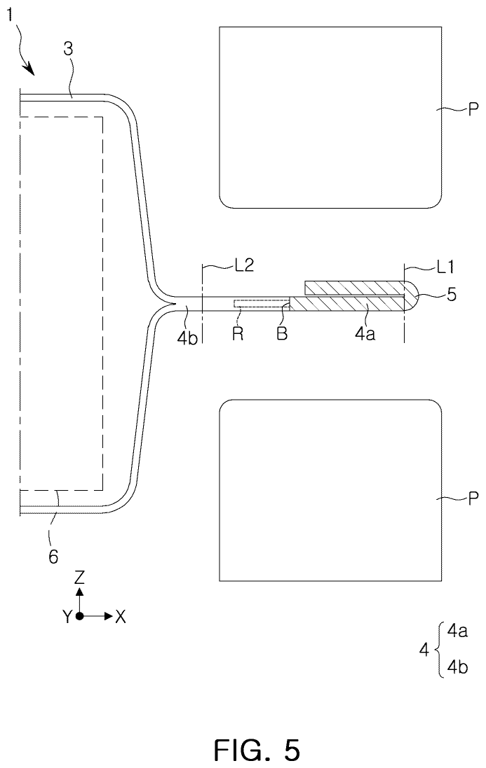

FIG. 2B illustrates a state in which a folding guide line 45 is formed on the terrace 40 of the battery cell 10. The folding guide line 45 may be formed as a line formed in a length direction of the terrace 40 and spaced apart from the electrode-accommodating portion 30 by a certain distance. The folding guide line 45 may have a groove shape. As an example, the folding guide line 45 may be formed by a folding guide line forming device (for example, 100 of FIG. 5) described below.

FIG. 2C illustrates the folded portion 50 in which the terrace 40 is folded based on the folding guide line 45 through a 1-1 folding process. The 1-1 folding process may be a process of folding the terrace 40 at a specific angle (for example, approximately 90 degrees). Since the folding guide line 45 having a groove shape is formed in advance on the terrace 40, the folded portion 50 may be easily formed by the folding guide line 45.

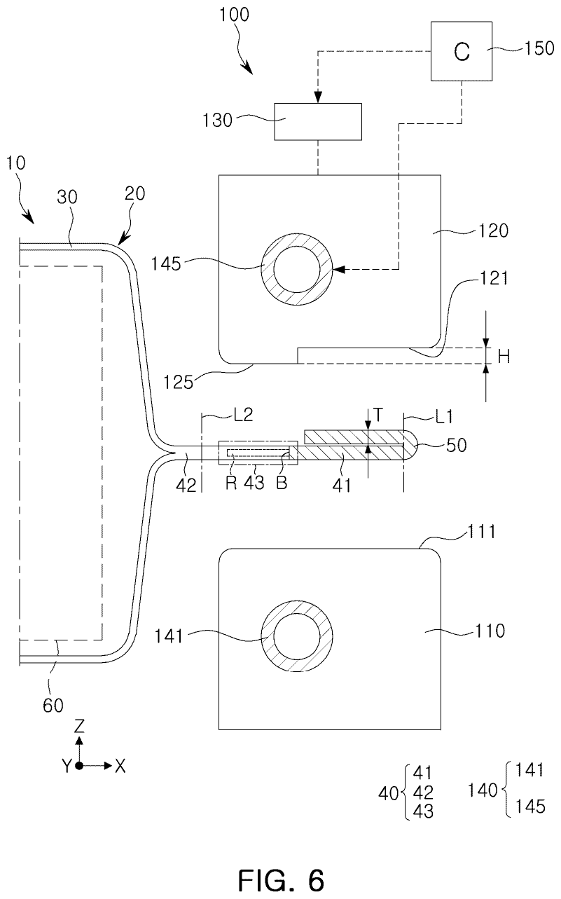

FIG. 2D illustrates a 1-2 folding process of additionally folding the terrace 40 based on the folding guide line 45. By the 1-2 folding process, the folded portion 50 may have a shape folded approximately 180 degrees. Although FIGS. 2C and 2D illustrate the 1-1 folding process and the 1-2 folding process as separate processes, but the 1-1 folding process and the 1-2 folding process may be performed as a single process. The 1-1 folding process and the 1-2 folding process may constitute a first folding operation. After the first folding operation, a pressing process may be performed to press the folded portion 50 to maintain a folded state of the folded portion 50. The pressing process may be performed by a heating press (100 of FIG. 6) according to the present disclosure as a process of restricting the folded portion 50 from being spread out or an end portion of the folded portion 50 from being spread out due to a springback phenomenon.

FIG. 2E illustrates a state in which an inner side guide line 46 is formed on the terrace 40 of the battery cell 10. The inner side guide line 46 may be formed between the electrode-accommodating portion 30 and the folding guide line 45. The inner side guide line 46 may be formed as a line formed in the length direction of the terrace 40 and spaced apart from the electrode-accommodating portion 30 by a certain distance. The inner side guide line 46 may have a groove shape. The inner side guide line 46 may be used for folding the terrace 40, like the folding guide line 45.

FIG. 2F illustrates a second folding process of additionally folding the terrace 40. The folded portion 50 may have a shape folded approximately 270 degrees by the second folding process. The second folding process may additionally fold the terrace 40 based on the inner side guide line 46. However, the second folding process may also be configured as a process for folding the terrace 40 in a state in which the inner side guide line 46 is not formed. The second folding process may constitute a second folding operation. After the second folding operation, a sizing operation for pressing the folded portion 50 toward the electrode-accommodating portion 30 to restrict the folded portion 50 folded 270 degrees from unfolding due to a springback phenomenon may be performed.

The folding guide line 45 may be formed to perform the first folding operation including the 1-1 folding process and the 1-2 folding process, and the inner side guide line 46 may be formed to perform the second folding operation including the second folding process. The folding process using the folding guide line 45 and the inner side guide line 46 is not limited to a process of folding at a specific angle such as 90 degrees, 180 degrees, or 270 degrees, as described above. For example, in an embodiment, the folding process using the folding guide line 45 and the inner side guide line 46 may be configured as a process of folding an angle of the terrace 40 by various angles such as 45 degrees, 60 degrees, 75 degrees, 120 degrees, 135 degrees, 150 degrees, 165 degrees, 195 degrees, 210 degrees, 225 degrees, 240 degrees, 255 degrees, 285 degrees, or the like. The number of times the folding process is performed may also be changed to one or more times. In this manner, setting of a folding angle for the terrace 40 or the number of times the folding process is performed may be changed in various manners depending on final specifications of the battery cell 10.

FIGS. 2A to 2F illustrate a configuration in which both the folding guide line 45 and the inner side guide line 46 are formed, the present disclosure may also be applied to an embodiment in which only the folding guide line 45 is formed and the inner side guide line 46 is not formed. For example, the second folding process illustrated in FIG. 2F may be performed without going through the process of forming the inner side guide line 46 illustrated in FIG. 2E.

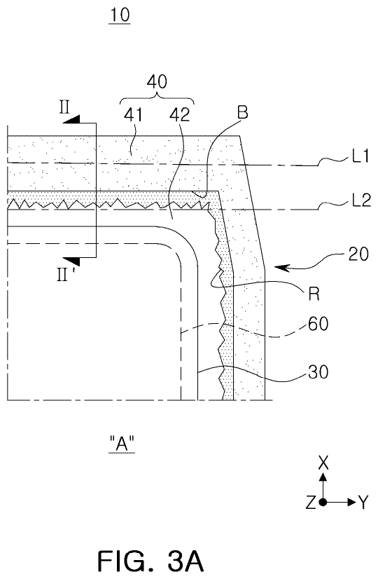

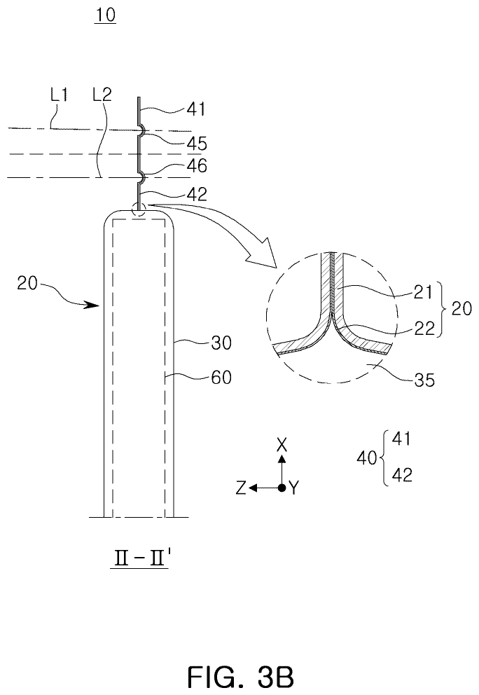

FIG. 3A is a schematic diagram illustrating an enlarged portion of portion “A” of FIG. 1, and FIG. 3B is a cross-sectional view illustrating a state in which a folding guide line 45 and an inner side guide line 46 are formed in a cross-section of FIG. 3A, taken along line II-II′.

Referring to FIG. 3A and FIG. 3B, the terrace 40 may include the sealed portion 41, which may be a sealed region, and the non-sealed portion 42, which may be a non-sealed region. The non-sealed portion 42 may be formed between the sealed portion 41 and the electrode-accommodating portion 30.

An outer side folding line L1 may be formed in the sealed portion 41. The outer side folding line L1 may be a virtual line along which the terrace 40 is first folded, and may correspond to the folding guide line 45. An inner side folding line L2 may be formed in the non-sealed portion 42. The inner side folding line L2 may be a virtual line used for the second folding that may be performed after the first folding, and may correspond to the inner side guide line 46.

The pouch case 20 may be formed as a plurality of layers. The pouch case 20 may have a shape in which an outer layer 21 and an inner layer 22 are stacked. The outer layer 21 may protect an internal component such as the electrode assembly 60 or the like, and the inner layer 22 may include a resin layer having adhesive properties.

The outer layer 21 may include a metal layer and an insulating layer. The metal layer may secure mechanical strength of the pouch case 20, and may prevent external air and moisture from flowing into an internal space of the battery cell 10. The metal layer may be composed of aluminum. In the aluminum, it is advantageous in that, while securing mechanical strength above a certain level, it is light in weight, and supplement for electrochemical properties of the electrode assembly 60 and the electrolyte, heat dissipation, or the like is provided. Various materials, other than aluminum, may be used for the metal layer.

The insulating layer may be provided on an outside of the metal layer with a material having electrical insulation properties, to protect the battery cell 10 from the outside, and, at the same time, electrically insulate the electrode assembly 60 and the metal layer from the outside.

The inner layer 22 may be formed on an inside of the outer layer 21. For example, the inner layer 22 may be formed on an inside of the metal layer. The inner layer 22 may be composed of a material having electrical insulation and adhesive properties. For example, the inner layer 22 may include cast polypropylene (CPP), polypropylene (PP), or the like.

The sealed portion 41 of the terrace 40 may be formed by heating and pressing inner layers 22 contacting each other through a sealing process, and thermally fusion thereof. Therefore, after the sealing process, the sealed portion 41 may be formed by melting a resin contained in the inner layer 22 in the heated and pressed portion and then curing the same.

Since the inner layer 22 may be heated and pressed in the sealing process, the resin contained in the inner layer 22 may be pushed out of the sealed portion 41 by pressing force in a molten state. In this case, the molten resin may move to the non-sealed portion 42.

The resin pushed out to the non-sealed portion 42 may be cured in an unstable form or irregularly to form an unstable region R. The unstable region R may extend from the boundary B between the sealed portion 41 and the non-sealed portion 42 toward the non-sealed portion 42. When the first and/or second folding processes are performed, cracks or the like may occur in the unstable region R, and thus, insulation breakdown may occur.

In addition, the resin melted in the sealing process and then pushed out to the non-sealed portion 42 may reach around the inner side folding line L2, and in this case, the unstable region R may overlap or be adjacent to the inner side folding line L2. When the unstable region R overlaps or is adjacent to the inner side folding line L2, insulation breakdown due to cracks or the like may occur at or near the inner side folding line L2 during the second folding process.

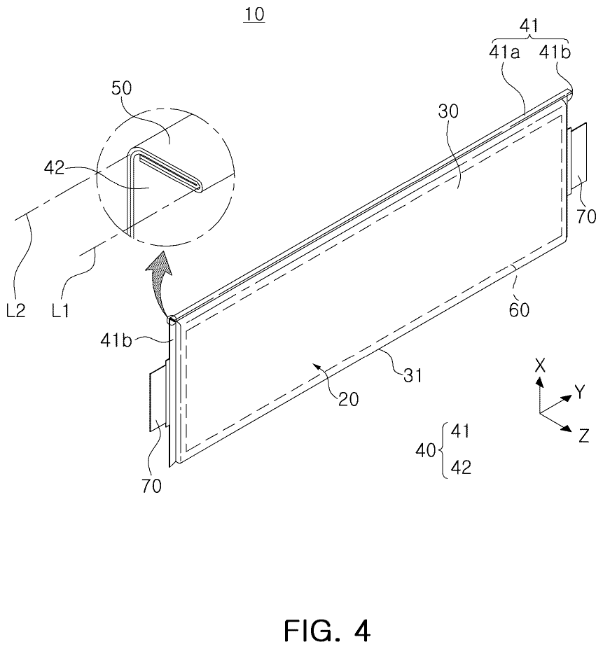

FIG. 4 is a perspective view illustrating a battery cell 10 according to an embodiment.

Referring to FIG. 4, a battery cell 10 may include a pouch case 20 and an electrode assembly 60 accommodated inside the pouch case 20. The pouch case 20 may include an electrode-accommodating portion 30 in which an accommodating space 35 for accommodating the electrode assembly 60 is formed, and a terrace around at least a portion of the electrode-accommodating portion 30. The terrace 40 may extend from the electrode-accommodating portion 30 in an outward direction.

The terrace 40 may include a sealed portion 41 and a non-sealed portion 42. The sealed portion 41 may include a first sealed portion 41a in which an electrode lead 70 is not disposed, and a second sealed portion 41b in which the electrode lead 70 is disposed. The first sealed portion 41a may be folded based on an outer side folding line L1 and then further folded based on an inner side folding line L2.

As in FIG. 4, a folded portion 50 is illustrated as having a 270-degree folded shape, but the folded portion 50 may be folded at an angle greater than 270 degrees. To prevent the folded portion 50 from being easily unfolded due to a springback phenomenon, the folded portion 50 may be attached to the electrode-accommodating portion 30 using a tape.

Hereinafter, a heating press 100 pressing a folded portion 50 formed on a terrace 40 disposed on at least a portion of a circumference of an electrode-accommodating portion 30 of a battery cell 10 will be described.

FIG. 5 is a schematic diagram illustrating a heating press P according to a comparative example.

A heating press P according to a comparative example may be a device pressing a folded portion 5 formed on a terrace 4 of a battery cell 1.

A battery cell 1 illustrated in FIG. 5 may include an electrode-accommodating portion 3 in which an electrode assembly 6 is accommodated, and a terrace 4. The terrace 4 may include a sealed portion 4a, which may be a sealed region, and a non-sealed portion 4b, which may be a non-sealed region. When the sealing process is performed, an unstable region R may be formed from a boundary B between the sealed portion 4a and the non-sealed portion 4b toward the electrode-accommodating portion 3. The unstable region R may extend from the boundary B toward the non-sealed portion 4b. The battery cell 1 may be folded 180 degrees based on an outer side folding line L1 to form a folded portion 5.

A heating press P according to a comparative example may press the folded portion 5 to prevent the 180-degree folded portion 5 from being spread out or an end portion from being spread due to a springback phenomenon. Since the heating press P according to the comparative example is configured to press only the folded portion 5, pressing of the folded portion 5 may not affect the unstable region R. Therefore, according to the comparative example, since secondary folding may be performed based on an inner side folding line L2 on the terrace 4 in a state having the unstable region R, a problem in which cracks or the like occur in the unstable region R or a region adjacent thereto, thereby lowering an insulation level or destroying insulation, may occur.

FIG. 6 is a schematic diagram illustrating a heating press 100 according to an embodiment.

A heating press 100 according to an embodiment may be configured to press a folded portion 50 formed on a terrace 40 disposed on at least a portion of a circumference of an electrode-accommodating portion 30 of a battery cell 10.

The heating press 100 may include a first press 110 and a second press 120, pressing the terrace 40 of the battery cell 10, with the terrace 40 interposed therebetween.

The first press 110 may include a first pressing surface 111 pressing one surface (first surface) of the folded portion 50. For example, the first pressing surface 111 may support a lower surface of the terrace 40. The first pressing surface 111 may be formed as a planar surface to contact one surface of the terrace 40. The first pressing surface 111 may be in contact with a non-sealed portion 42 and a sealed portion 41 of the terrace 40, and the folded portion 50. The first pressing surface 111 may press the folded portion 50, together with a second pressing surface 121 to be described below, and, at the same time, may press an inner side region 43 of the terrace 40, together with a protruding pressing surface 125.

The second press 120 may include the second pressing surface 121 pressing the other surface (second surface) of the folded portion 50, and the protruding pressing surface 125 pressing the inner side region 43 of the terrace 40.

The second pressing surface 121 may press the folded portion 50 together with the first pressing surface 111. The folded portion 50 may have a shape in which the sealed portion 41 of the terrace 40 is folded 180 degrees and overlapped. The folded portion 50 may have a shape in which the sealed portion 41 overlaps by folding based on an outer side folding line L1. Therefore, an overall thickness of the folded portion 50 may correspond to twice a thickness T of the sealed portion 41.

The protruding pressing surface 125 may protrude from the second pressing surface 121 toward the first pressing surface 111. The protruding pressing surface 125 may include a planar surface protruding from the second pressing surface 121 to a preset height H.

The preset height H of the protruding pressing surface 125 may have a value between 0.8 and 1.2 times the thickness T of the sealed portion 41 of the terrace 40. For example, when the thickness of the sealed portion 41 is 250 μm, the preset height H of the protruding pressing surface 125 may have a value of 200 to 300 μm.

A thickness of the folded portion 50 may be reduced by pressing of the second pressing surface 121. Therefore, when pressing force or a pressing depth of the second pressing surface 121 is set to be large, pressing of the inner side region 43 is possible even when the preset height H of the protruding pressing surface 125 is smaller than the thickness T of the sealed portion 41.

When pressing force or a pressing depth of the protruding pressing surface 125 is set to be large or the folded portion 50 does not completely overlap, a lifted state may be maintained. In this case, even when the preset height H of the protruding pressing surface 125 is greater than the thickness T of the sealed portion 41, the inner side region 43 may be pressed.

In this manner, the preset height H of the protruding pressing surface 125 may be adjusted by a shape or a thickness of the folded portion 50, a thickness of the sealed portion 41, pressing force applied to the folded portion 50, pressing force applied to the inner side region 43, or the like.

The protruding pressing surface 125 may press the inner side region 43 of the terrace 40, together with the first pressing surface 111. The inner side region 43 may be defined as a region pressed by the protruding pressing surface 125. The inner side region 43 may be located between the folded portion 50 and the electrode-accommodating portion 30. The inner side region 43 pressed by the protruding pressing surface 125 may include a region in which the folded portion 50 does not overlap. For example, the protruding pressing surface 125 may be configured not to press or contact the folded portion 50.

The terrace 40 may include the sealed portion 41, which may be a sealed region, and the non-sealed portion 42, which may be a non-sealed region. The inner side region 43 pressed by the protruding pressing surface 125 may include at least a portion of the non-sealed portion 42.

The inner side region 43 may include at least a portion of an unstable region R, as described in FIG. 3A. The inner side region 43 may include a region in which a molten resin is pushed out of the sealed portion 41 during the sealing process and cured in an unstable form or irregularly cured. The unstable region R may correspond to a region extending from a boundary B between the sealed portion 41 and the non-sealed portion 42 toward the non-sealed portion 42. The inner side region 43 may include a region in which insulation breakdown may occur due to cracks or the like in a conventional folding process.

The inner side region 43 may include a boundary B between the sealed portion 41 and the non-sealed portion 42, and in this case, the protruding pressing surface 125 may simultaneously press a portion of the sealed portion 41 and a portion of the non-sealed portion 42.

The protruding pressing surface 125 may be configured to stabilize the unstable region R by heating the inner side region 43 to a preset temperature while pressing the inner side region 43. Since the unstable region R may be a region formed by a resin melt in the sealed portion 41 being pushed outwardly from the sealed portion 41 and cured during the sealing process, a thickness of the cured resin layer may be uneven, a shape may be irregular, and properties also have different values depending on a position. According to an embodiment, the unstable region R may be stabilized by the protruding pressing surface 125, other insulation destruction factors such as cracks or the like may be eliminated.

A heating press 100 according to an embodiment may additionally include a heating unit 140. The heating unit 140 may heat at least one of the first press 110 or the second press 120. The heating unit 140 may include at least one of a first heater 141 for heating the first press 110 or a second heater 145 for heating the second press 120.

A preset temperature of the heating unit 140 may have a lower value than a heating temperature of a sealing process of forming the sealed portion 41 on the terrace 40. Heating and pressing for the inner side region 43 may have a lower value than a heating temperature and pressing force of the sealing process. For example, since a pressing process by the heating press 100 may be in a state in which the sealed portion 41 is already formed in the sealing process, heating by the heating press 100 may be configured to alleviate the unstable region R, for example, unevenness of the inner side region 43, under conditions more relaxed than the sealing process.

The protruding pressing surface 125 may simultaneously heat a portion of the sealed portion 41 and a portion of the non-sealed portion 42. The protruding pressing surface 125 may heat the unstable region R of the terrace 40 to melt a resin layer such that a thickness and/or properties of a cured resin layer become uniform. Therefore, insulation performance of the terrace 40 may be improved or restored, and insulation performance of the battery cell 10 may be improved, as compared to a previous process.

A heating temperature of the inner side region 43 pressed by the protruding pressing surface 125 may be set to have a value suitable for a specific purpose of stabilizing the unstable region R, for example, in terms of softening the cured resin layer or forming a new sealing region. For example, the heating temperature of the inner side region pressed by the protruding pressing surface 125 may be 0.7 to 1.2 times a melting temperature of a resin layer provided on the terrace 40.

To stabilize the unstable region R through softening the cured resin layer, a heating temperature of the protruding pressing surface 125 may be set to a value lower than a melting temperature of the resin layer provided on the terrace 40. In this case, the heating temperature of the protruding pressing surface 125 may have a value of about 0.7 times equal to or higher than the melting temperature of the resin layer and lower than the melting temperature, based on Celsius. For example, when the melting temperature of the resin layer is 150 degrees, a temperature of the protruding pressing surface 125 for softening the cured resin layer may have a value of 100 degrees or higher and 150 degrees or lower.

Similar to the sealing process, to stabilize the unstable region R through formation of a new sealing region, the heating temperature of the protruding pressing surface 125 may have a value equal to or higher than the melting temperature of the resin layer provided on the terrace 40. In this case, the heating temperature of the protruding pressing surface 125 may have a value equal to or higher than the melting temperature of the resin layer and a value of about 1.2 times equal to or lower than the melting temperature, based on Celsius. For example, when the melting temperature of the resin layer is 150 degrees, a temperature of the protruding pressing surface 125 for softening the cured resin layer may have a value of 150 degrees or higher and 180 degrees or lower. The heating temperature of the protruding pressing surface 125 may have a lower value than the heating temperature of the sealing process.

A heating press 100 according to an embodiment may additionally include a driving unit 130. The driving unit 130 may drive at least one of the first press 110 or the second press 120 such that the first press 110 and the second press 120 move relative to each other in the second direction (Z). For example, when the first press 110 has a fixed position, the driving unit 130 may elevate the second press 120. The driving unit may be configured to drive the second press 120, or may be configured to drive both the first press 110 and the second press 120.

A control unit 150 may control driving of the driving unit 130 and heating of the heating unit 140. A heating temperature of the heating unit 140 and pressing force and a pressing time by the driving unit 130 may be set to appropriate values considering a melting temperature of the resin layer included in the pouch case 20, a thickness T of the sealed portion 41, an overall thickness of the folding unit 50, pressing force applied to the folding unit 50 and the inner side region 43, or the like. At least one of a temperature, pressing force, a pressing time, or a pressing height of the first press 110 and the second press 120 may be controlled by control of the control unit 150.

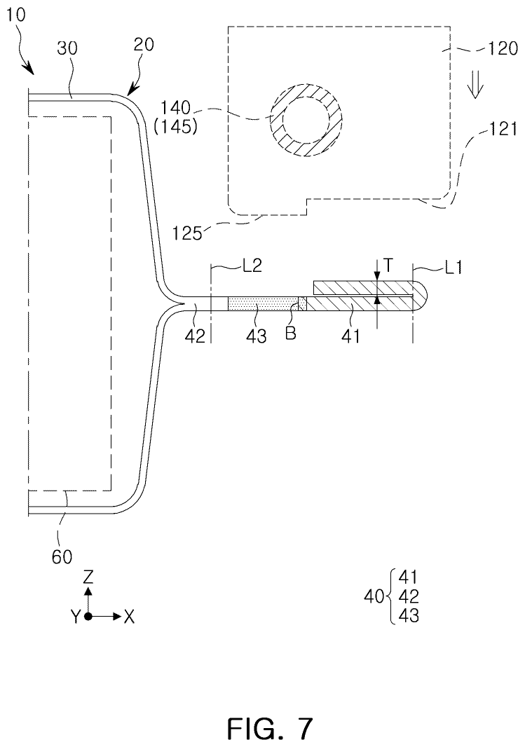

FIG. 7 is a schematic diagram of a battery cell 10 processed by the heating press 100 of FIG. 6.

FIG. 7 illustrates a state in which an inner side region 43 and a folding unit 50 folded 180 degrees based on an outer side folding line L1 is pressed by the heating press 100 of FIG. 6.

In FIG. 7, an inner side region 43 may be formed across a sealed portion 41 and a non-sealed portion 42, including a boundary B between the sealed portion 41 and the non-sealed portion 42. The inner side region 43 may include an unstable region R, and the inner side region 43 pressed and heated by a protruding pressing surface 125 may have a stabilized state. Therefore, insulation performance of a battery cell 10 may be restored or the insulation performance of the battery cell 10 may be improved, as compared to a previous process.

In this manner, since the inner side region 43, for example, the unstable region R, may be stabilized, secondary folding may be performed based on an inner side folding line L2, such that an insulation defect of the battery cell 10 may be reduced in the secondary folding process and subsequent processes.

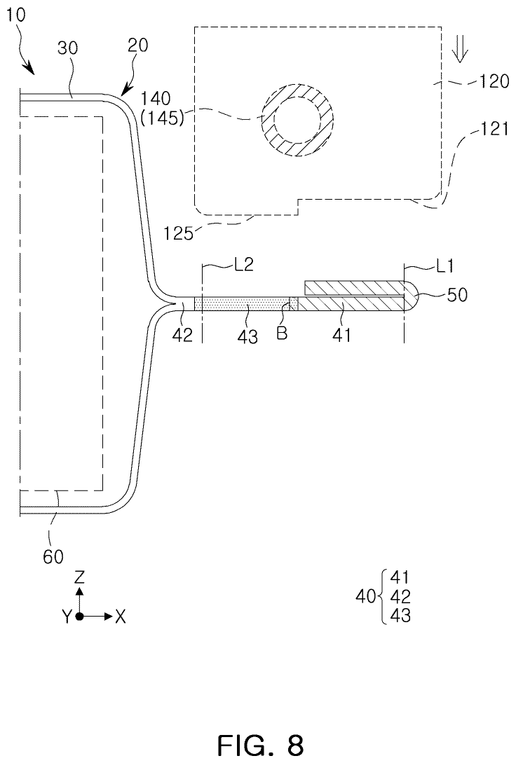

FIG. 8 is a schematic diagram of a battery cell 10 processed by a heating press 100 according to a modified embodiment.

FIG. 8 illustrates an enlarged form of an inner side region 43 pressed by a protruding pressing surface 125, as compared to FIG. 7.

In the modified embodiment of FIG. 8, the inner side region 43 may include a region in which an inner side folding line L2 is located. The inner side folding line L2 may be located between an outer side folding line L1 and an electrode-accommodating portion 30, and may be provided for secondary folding of a terrace 40.

In this manner, when the inner side region 43 is expanded to a region including the inner side folding line L2, a stabilized region may increase to prevent insulation breakdown or insulation performance degradation due to cracks or the like during a secondary folding process.

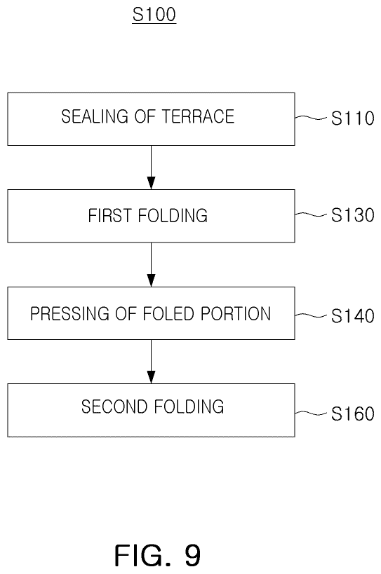

FIG. 9 is a flow chart illustrating a method (S100) for manufacturing a battery cell 10 according to an embodiment.

Referring to FIG. 9 together with FIGS. 2A to 2F and 6, a method (S100) for manufacturing a battery cell 10 may include a sealing process (S110), a first folding process (S130), a pressing process (S140), and a second folding process (S160).

The sealing process (S110) may be a process of forming a sealed portion 41 on a terrace 40 disposed at least a portion of a circumference of an electrode-accommodating portion 30 of a pouch case. A battery cell 10 that has undergone the sealing process (S110) may have a shape of FIG. 2A.

The first folding process (S130) may be a process of first folding the sealed portion 41, based on an outer side folding line L1, to form a folded portion 50. The first folding process (S130) may correspond to FIGS. 2B and 2C. The folded portion 50 that has undergone the first folding process (S130) may have a shape in which the sealed portion 41 is folded 180 degrees and overlaps.

The pressing process (S140) may be a process of pressing the folded portion 50. The pressing process ((S140) may be performed by a heating press 100, as illustrated in FIG. 6. The pressing process (S140) may be configured to press an inner side region 43 located between the folded portion 50 and the electrode-accommodating portion 30, together with the folded portion 50.

The inner side region 43 pressed in the pressing process (S140) may include a region in which the folded portion 50 does not overlap. In addition, the terrace 40 may include the sealed portion 41, which may be a sealed region, and the non-sealed portion 42, which may be an unsealed region, and the inner side region 43 pressed in the pressing process (S140) may include at least a portion of a non-sealed portion 42. The inner side region 43 may include a boundary between the sealed portion 41 and the non-sealed portion 42, and the pressing process (S140) may be configured to press a portion of the sealed portion 41 and a portion of the non-sealed portion 42 simultaneously. Since the pressing process (S140) may correspond to the heating press 100, as described in FIGS. 6 and 7, a detailed description thereof will be omitted.

The secondary folding process (S160) may be a process of additionally folding the folded portion 50 folded 180 degrees based on an inner side folding line L2. The battery cell 10 that has undergone the secondary folding process (S160) may have a shape of FIG. 2F. The folded portion 50 that has undergone the secondary folding process (S160) may have a shape in which the sealed portion 41 is folded 270 degrees. For example, the folded portion 50 that has undergone the secondary folding process (S160) may have a shape in which the folded portion 50 that has been folded 180 degrees in the first folding process is additionally folded 90 degrees.

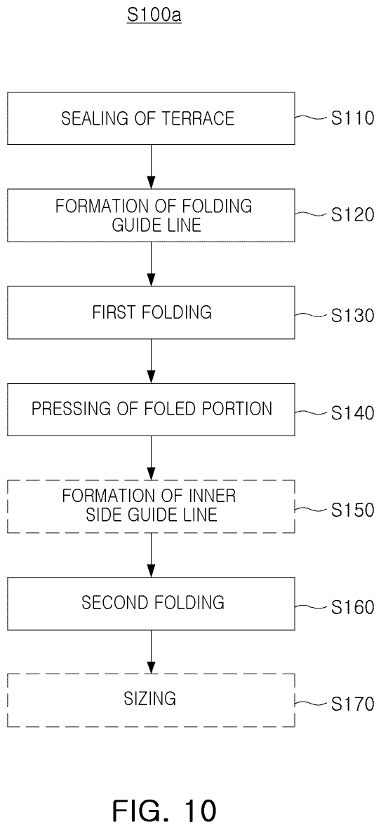

FIG. 10 is a flow chart illustrating a method (100a) for manufacturing a battery cell 10 according to another embodiment.

A method (S100a) for manufacturing a battery cell 10, illustrated in FIG. 10, may be different from the method (S100) for manufacturing a battery cell 10, illustrated in FIG. 9 in view that it additionally includes at least a portion of a folding guide line forming process (S120), an inner side guide line forming process (S150), and a sizing process (S170).

The folding guide line forming process (S120) may be a process of forming a folding guide line (45 in FIG. 3B) corresponding to an outer side folding line L1.

The inner side guide line forming process (S150) may be a process of forming an inner side guide line (46 in FIG. 3B) corresponding to an inner side folding line L2.

The folding guide line 45 and the inner side guide line 46 may be formed as lines formed in a length direction of the terrace 40. The folding guide line 45 and the inner side guide line 46 may have a groove shape.

The sizing process (S170) may be a process of pressing the folded portion 50 toward the electrode-accommodating portion 30 to prevent the folded portion 50 folded at 270 degrees from unfolding due to a springback phenomenon after the second folding operation.

According to an embodiment of the present disclosure, insulation performance of a battery cell may be improved.

In addition, according to an embodiment of the present disclosure, a phenomenon in which thicknesses and properties of a resin layer are uneven in a region in which a molten resin is pushed toward a non-sealed portion may be alleviated.

In addition, according to an embodiment of the present disclosure, insulation performance of a battery cell may be restored, or the insulation performance of the battery cell may be improved, as compared to a previous process.

In addition, according to an embodiment of the present disclosure, an insulation defect of a battery cell may be reduced.

Only specific examples of implementations of certain embodiments may be described. Variations, improvements and enhancements of the disclosed embodiments and other embodiments may be made based on the disclosure of this patent document.

What is claimed is:

1. A heating press for pressing a folded portion formed on a terrace disposed on at least a portion of a circumference of an electrode-accommodating portion of a battery cell, comprising:
a first press including a first pressing surface pressing a first surface of the folded portion; and
a second press including a second pressing surface pressing a second surface of the folded portion and a protruding pressing surface pressing an inner side region of the terrace,
wherein the protruding pressing surface protrudes from the second pressing surface toward the first pressing surface and presses the inner side region together with the first pressing surface, and
the inner side region is located between the folded portion and the electrode-accommodating portion.

2. The heating press of claim 1, wherein the folded portion has a shape in which a sealed portion of the terrace is folded 180 degrees and overlaps, and
the inner side region pressed by the protruding pressing surface includes a region in which the folded portion does not overlap.

3. The heating press of claim 1, wherein the terrace includes a sealed portion, which is a sealed region, and a non-sealed portion, which is an unsealed region, and
the inner side region pressed by the protruding pressing surface includes at least a portion of the non-sealed portion.

4. The heating press of claim 3, wherein the inner side region includes a boundary between the sealed portion and the non-sealed portion, and
the protruding pressing surface simultaneously presses a portion of the sealed portion and a portion of the non-sealed portion.

5. The heating press of claim 3, wherein the folded portion has a shape in which the sealed portion overlaps by folding based on an outer side folding line, and
the inner side region includes a region in which an inner side folding line is located, the inner side folding line being provided for folding the terrace between the outer side folding line and the electrode-accommodating portion.

6. The heating press of claim 1, wherein the protruding pressing surface includes a planar surface protruding from the second pressing surface to a preset height.

7. The heating press of claim 6, wherein the preset height has a value between 0.8 and 1.2 times a thickness of a sealed portion of the terrace.

8. The heating press of claim 1, wherein the first pressing surface presses the folded portion, together with the second pressing surface.

9. The heating press of claim 1, further comprising a heating unit heating at least one of the first press or the second press,
wherein a preset temperature of the heating unit has a value lower than a heating temperature of a process of forming a sealed portion on the terrace.

10. The heating press of claim 1, wherein a heating temperature of the inner side region pressed by the protruding pressing surface is lower than a melting temperature of a resin layer provided on the terrace.

11. The heating press of claim 1, wherein a heating temperature of the inner side region pressed by the protruding pressing surface is 0.7 to 1.2 times a melting temperature of a resin layer provided on the terrace.

12. A method for manufacturing a battery cell, comprising:
a sealing process of forming a sealed portion on a terrace disposed on at least a portion of a circumference of an electrode-accommodating portion of a pouch case;
a first folding process of first folding the sealed portion based on an outer side folding line to form a folded portion;
a pressing process of pressing the folded portion; and
a second folding process of additionally folding the folded portion based on an inner side folding line,
wherein the pressing process presses an inner side region located between the folded portion and the electrode-accommodating portion, together with the folded portion.

13. The method of claim 12, wherein the folded portion has a shape in which the sealed portion is folded 180 degrees and overlaps, and
the inner side region pressed in the pressing process includes a region in which the folded portion does not overlap.

14. The method of claim 12, wherein the terrace includes the sealed portion and a non-sealed portion, which is an unsealed region, and
the inner side region pressed in the pressing process includes at least a portion of the non-sealed portion.

15. The method of claim 14, wherein the inner side region includes a boundary between the sealed portion and the non-sealed portion, and
the pressing process simultaneously presses a portion of the sealed portion and a portion of the non-sealed portion.
